(19) United States
(12) Patent Application Publication
(10) Pub. No.: US 2021/0206064 A1
(43) Pub. Date: Jul. 8, 2021

(54) THREE-DIMENSIONAL PRINTING APPARATUS HAVING ELECTROSTATIC AUXILIARY

(71) Applicant: Industrial Technology Research Institute, Hsinchu (TW)

(72) Inventors: Hsin-Hsin Shen, Hsinchu County (TW); Chang-Chou Li, Tainan City (TW); Li-Wen Lai, Tainan City (TW); Yu-Bing Liou, Hsinchu City (TW); Ying-Wen Shen, Miaoli County (TW)

(73) Assignee: Industrial Technology Research Institute, Hsinchu (TW)

(21) Appl. No.: 17/129,920

(22) Filed: Dec. 22, 2020

Related U.S. Application Data
(60) Provisional application No. 62/953,124, filed on Dec. 23, 2019.

(30) Foreign Application Priority Data
Jun. 10, 2020 (TW) 109119489

(51) Int. Cl. B29C 64/209; B29C 64/112; B29C 64/245; B29C 64/364

(52) U.S. Cl. CPC B29C 64/209; B29C 64/112; B33Y 30/00; B29C 64/364; B29C 64/245

(57) ABSTRACT

A three-dimensional printing apparatus having electrostatic auxiliary, including a printing platform, a feeding device, a nozzle, and a high voltage power supply, is provided. The feeding device and the nozzle are disposed above the printing platform. The nozzle is connected to the feeding device and is located between the feeding device and the printing platform. A distance between the nozzle and the printing platform is less than or equal to 1 cm. The high voltage power supply has an output end electrically connected to the nozzle and a ground end electrically connected to the printing platform.

### CROSS-REFERENCE TO RELATED APPLICATION

This application claims the priority benefit of U.S. provisional application Ser. No. 62/953,124, filed on Dec. 23, 2019, the disclosure of which is incorporated by reference herein in its entirety, and claims the benefit of Taiwan application serial no. 109119489, filed Jun. 10, 2020, the subject matter of which is incorporated herein by reference.

### BACKGROUND

### Technical Field

This disclosure relates to a three-dimensional printing technology, and in particular to a three-dimensional printing apparatus having electrostatic auxiliary.

### Description of Related Art

Regenerative medicine may be roughly divided into four major fields, among which the development of cell therapy and tissue engineering is more mature. In detail, tissue engineering has to integrate professional knowledge and technologies in biology, medicine, material science, and the like to develop related products for wound repair, tissue reconstruction, organ reconstruction, and surgical auxiliary equipment (for example, stents). With the maturity of three-dimensional printing technology, after introducing three-dimensional printing technology to tissue engineering, tissues, organs, and surgical auxiliary equipment with complex structures and special functions are able to be created gradually.

Artificial biological tissue may be roughly divided into a membrane layer and a nuclear layer covered by the membrane layer. The membrane layer may be analogized to an extracellular matrix, and the nuclear layer may be analogized to a cell and an intercellular substance thereof. Therefore, during the process of using three-dimensional printing technology to make artificial biological tissues, the membrane layer material is continuously extruded, while depending on the distribution of cells and intercellular substance, the nuclear layer material is intermittently extruded to be covered by the membrane layer material.

As the application of three-dimensional printing technology to artificial biological tissues is mainly based on the extrusion method, there are mostly issues such as the diameter of the extruded filament being too large or the diameter of the extruded filament being fixed and unchangeable.

### SUMMARY

A three-dimensional printing apparatus having electrostatic auxiliary according to an embodiment of the disclosure includes a printing platform, a feeding device, a nozzle, and a high voltage power supply. The feeding device and the nozzle are disposed above the printing platform. The nozzle is connected to the feeding device and is located between the feeding device and the printing platform. A distance between the nozzle and the printing platform is less than or equal to 1 cm. The high voltage power supply has an output end and a ground end.

The output end is electrically connected to the nozzle and the ground end is electrically connected to the printing platform.

To make the aforementioned more comprehensible, several embodiments accompanied by drawings are described in detail as follows.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic view of a three-dimensional printing apparatus having electrostatic auxiliary according to an embodiment of the disclosure.

FIG. 2 is a partially enlarged schematic view of an area A in FIG. 1.

FIG. 3 is a cross-sectional schematic view of a nozzle in FIG. 2.

FIG. 4 is a comparison schematic view of the voltage change of a high voltage power supply and the cross-sectional change of a micron fiber in FIG. 1.

### DESCRIPTION OF THE EMBODIMENTS

The disclosure provides a three-dimensional printing apparatus having electrostatic auxiliary, which helps to reduce the diameter of an extruded filament and control the size of the diameter of the extruded filament.

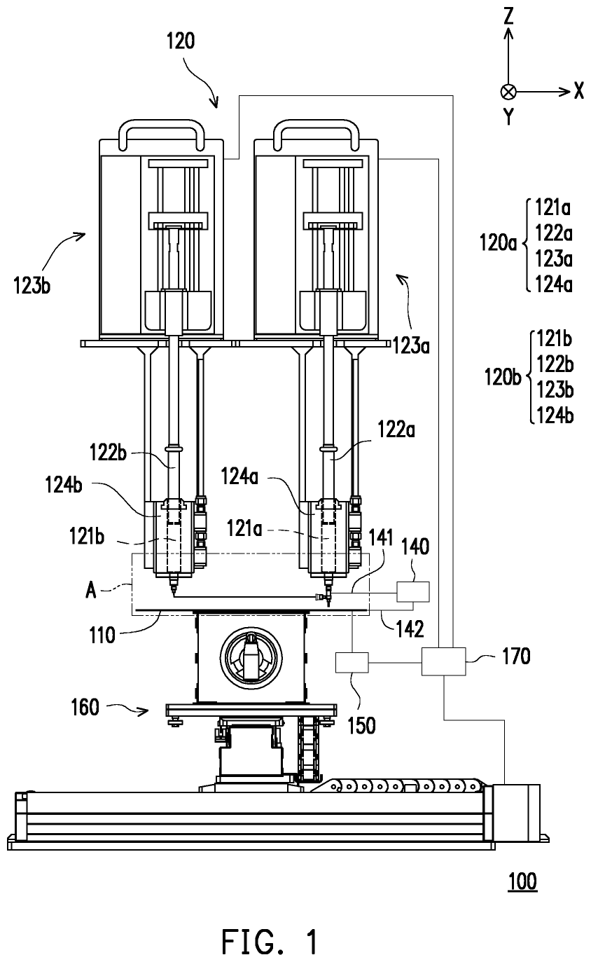

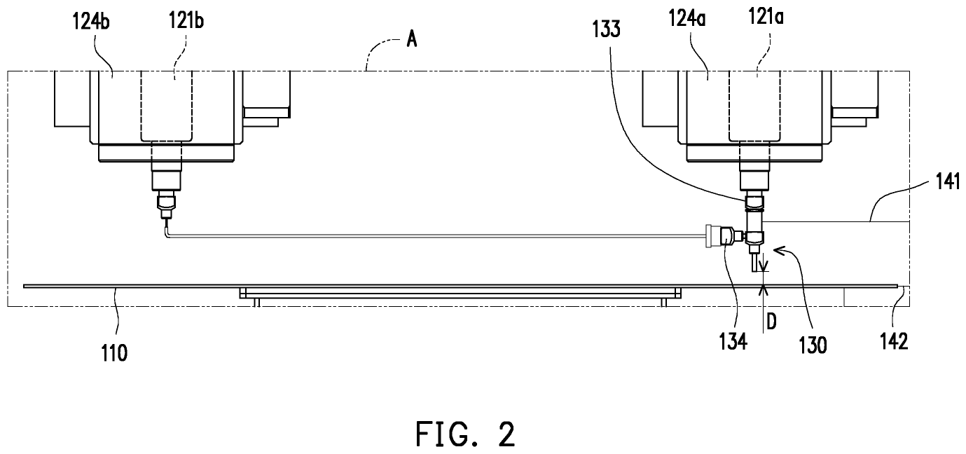

FIG. 1 is a schematic view of a three-dimensional printing apparatus having electrostatic auxiliary according to an embodiment of the disclosure. FIG. 2 is a partially enlarged schematic view of an area A in FIG. 1. With reference to FIGS. 1 and 2, in the embodiment, a three-dimensional printing apparatus having electrostatic auxiliary 100 includes a printing platform 110, a feeding device 120, a nozzle 130, and a high voltage power supply 140. The feeding device 120 and the nozzle 130 are disposed above the printing platform 110, and the feeding device 120 and the nozzle 130 have a degree of freedom of motion to move along the Z-axis in space. In addition, the printing platform 110 has a degree of freedom of motion to move along the X-axis, Y-axis, and Z-axis in space.

The nozzle 130 is connected to the feeding device 120 and is located between the feeding device 120 and the printing platform 110. The feeding device 120 is adapted to provide a printing material to the nozzle 130 to be extruded from the nozzle 130 for deposition modeling on the printing platform 110. In detail, the high voltage power supply 140 has an output end 141 and a ground end 142. The output end 141 is electrically connected to the nozzle 130, and the ground end 142 is electrically connected to the printing platform 110. When the high voltage power supply 140 is activated, a high voltage electric field may be formed between the nozzle 130 and the printing platform 110. Accordingly, the printing material extruded from the nozzle 130 is pulled by the high voltage electric field to form a micron fiber, which is deposition modelled on the printing platform 110. In other words, the three-dimensional printing apparatus having electrostatic auxiliary 100 can reduce a diameter of an extruded filament of the printing material. For example, the diameter of the extruded filament of the printing material is controlled to be between 80 microns and 450 microns.

On the other hand, a distance D between the nozzle 130 and the printing platform 110 is less than or equal to 1 cm. Even when there is variation in the level of the output voltage, the high voltage electric field between the nozzle 130 and the printing platform 110 still have enough strength to accurately deposition model the micron fiber on the printing platform 110 according to a printing pattern or a printing path.

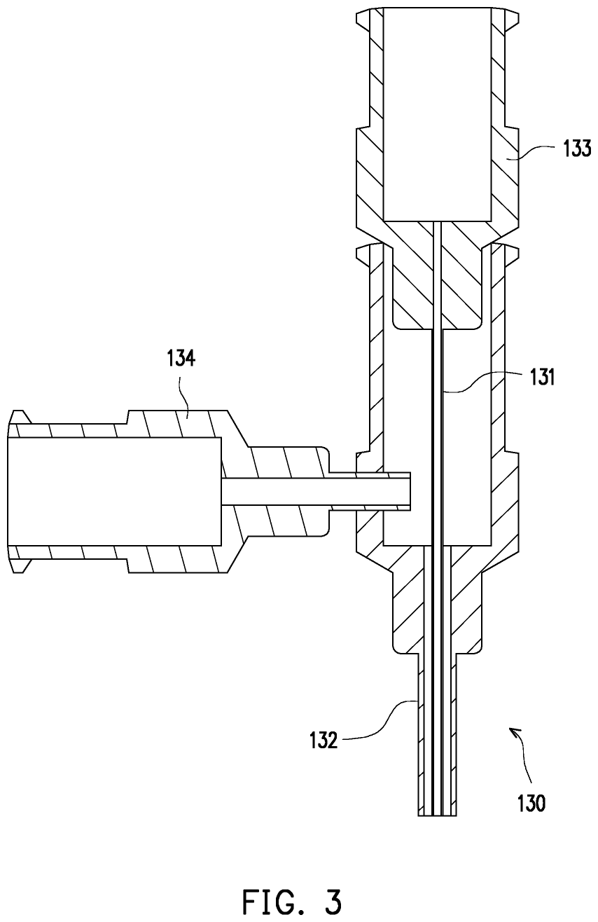

FIG. 3 is a cross-sectional schematic view of a nozzle in FIG. 2. With reference to FIGS. 1 to 3, in the embodiment, the feeding device 120 includes a first feeding device 120a and a second feeding device 120b juxtaposed with the first feeding device 120a. The first feeding device 120a is adapted to provide a nuclear layer material to the nozzle 130, and the second feeding device 120b is adapted to provide a membrane layer material to the nozzle 130. For example, the nuclear layer material may be a cell solution, a drug solution, or other biological solutions, and the membrane layer material may be a solution prepared from polyvinyl alcohol (PVA) or a solution prepared from other biocompatible materials.

When the solution is extruded from the nozzle 130, electric charges accumulate on a surface of a droplet under the effect of the high voltage electric field, and the droplet bears an electric field force opposite to surface tension. When the high voltage electric field is gradually strengthened, the droplet is stretched from a hemispherical shape into a cone shape, and a Taylor cone is formed. Once the strength of the high voltage electric field reaches a threshold, the electric field force overcomes the surface tension of the droplet, and the droplet breaks away from the nozzle 130 and a liquid column is ejected toward the printing platform 110.

In detail, the nozzle 130 includes a first discharge tube 131 and a second discharge tube 132 surrounding the first discharge tube 131. The first discharge tube 131 serves as an inner tube and the first feeding device 120a is connected to the first discharge tube 131. The second discharge tube 132 serves as an outer tube and the second feeding device 120b is connected to the second discharge tube 132. The first discharge tube 131 and the second discharge tube 132 are in a coaxial configuration. When the nuclear layer material is extruded from the first discharge tube 131 and the membrane layer material is extruded from the second discharge tube 132, the nuclear layer material is covered by the membrane layer material. The nuclear layer material and the membrane layer material are pulled by the high voltage electric field to form the micron fiber, which is deposition modelled on the printing platform 110.

For example, the first discharge tube 131 and the second discharge tube 132 are metal tubes with good conductivity, and are fixedly connected to each other. On the other hand, the output end 141 of the high voltage power supply 140 is wound around the nozzle 130 through a copper wire, so as to apply a same high voltage to the first discharge tube 131 and the second discharge tube 132 accordingly.

Furthermore, the nozzle 130 further includes a first connecting tube 133 and a second connecting tube 134. The first feeding device 120a is connected to the first discharge tube 131 through the first connecting tube 133 and the second feeding device 120b is connected to the second discharge tube 132 through the second connecting tube 134. In other words, the nuclear layer material is delivered from the first feeding device 120a to the first discharge tube 131 via the first connecting tube 133, and the membrane layer material is delivered from the second feeding device 120b to the second discharge tube 132 via the second connecting tube 134.

In the embodiment, the first feeding device 120a includes a syringe 121a, a plunger 122a, and a pushing mechanism 123a. The syringe 121a is adapted to store the nuclear layer material and is connected to the first connecting tube 133. The plunger 122a is inserted into the syringe 121a and is adapted to push the nuclear layer material. The pushing mechanism 123a abuts the plunger 122a and is adapted to control a discharge amount and a discharge speed of the nuclear layer material. For example, the pushing mechanism 123a includes a stepper motor, a screw rod, and a pushing member. The stepper motor is adapted to drive the screw rod to rotate and precisely control a rotational amount of the screw rod. The rotating screw rod is adapted to drive the pushing member to move, so that the pushing member pushes the plunger 122a, thereby precisely controlling the discharge amount and the discharge speed of the nuclear layer material.

Similarly, the second feeding device 120b includes a syringe 121b, a plunger 122b, and a pushing mechanism 123b. The syringe 121b is adapted to store the membrane layer material and is connected to the second connecting tube 134. The plunger 122b is inserted into the syringe 121b and is adapted to push the membrane layer material. The pushing mechanism 123b abuts the plunger 122b and is adapted to control a discharge amount and a discharge speed of the membrane layer material. For example, the pushing mechanism 123b includes a stepper motor, a screw rod, and a pushing member. The stepper motor is adapted to drive the screw rod to rotate and precisely control a rotational amount of the screw rod. The rotating screw rod is adapted to drive the pushing member to move, so that the pushing member pushes the plunger 122b, thereby precisely controlling the discharge amount and the discharge speed of the membrane layer material.

During a printing process, the first feeding device 120a and the second feeding device 120b are maintained at a first temperature, and the first temperature may be between 4° C. and 80° C. In detail, the first feeding device 120a includes a temperature control unit 124a, and the syringe 121a penetrates the temperature control unit 124a. The temperature control unit 124a may use a fluid circulator to maintain the nuclear layer material in the syringe 121a to be below a specific temperature. Similarly, the second feeding device 120b includes a temperature control unit 124b, and the syringe 121b penetrates the temperature control unit 124b. The temperature control unit 124b may use a fluid circulator to maintain the membrane layer material in the syringe 121b to be below a specific temperature.

On the other hand, the printing platform 110 is maintained at a second temperature, and the second temperature may be between 4° C. and 80° C. For example, the first temperature is lower than the second temperature. If the first temperature is 4° C., the second temperature is 37° C., which is, for example, similar to the body temperature of a human body. In detail, the three-dimensional printing apparatus having electrostatic auxiliary 100 further includes a temperature control device 15. The temperature control device 150 is connected to the printing platform 110, and the temperature control device 150 may use an electronic temperature controller to maintain the printing platform 110 to be at a specific temperature.

In the embodiment, the three-dimensional printing apparatus having electrostatic auxiliary 100 further includes a three-dimensional movement mechanism 160 and a controller 170. The printing platform 110 is connected to the three-dimensional movement mechanism 160 and the printing platform 110 is located between the nozzle 130 and the three-dimensional movement mechanism 160. The three-dimensional movement mechanism 160 is adapted to drive the printing platform 110 to move along the X-axis, Y-axis, and Z-axis in space.

On the other hand, the controller 170 may be a central processing unit, a graphics processor, an application specific integrated circuit (ASIC), or a field programmable logic gate array (FPGA), and has an external or built-in memory. In detail, the controller 170 is electrically connected to the feeding device 120, the high voltage power supply 140, the temperature control device 150, and the three-dimensional movement mechanism 160. The controller 170 is adapted to control the discharge amount, the discharge speed, a discharge time sequence, and a storage temperature (that is, the first temperature) of the nuclear layer material and the membrane layer material; control the level of the output voltage of the high voltage power supply 140; control the temperature of the printing platform 110 (that is, the second temperature); and control an amount of movement and a direction of movement of the printing platform 110.

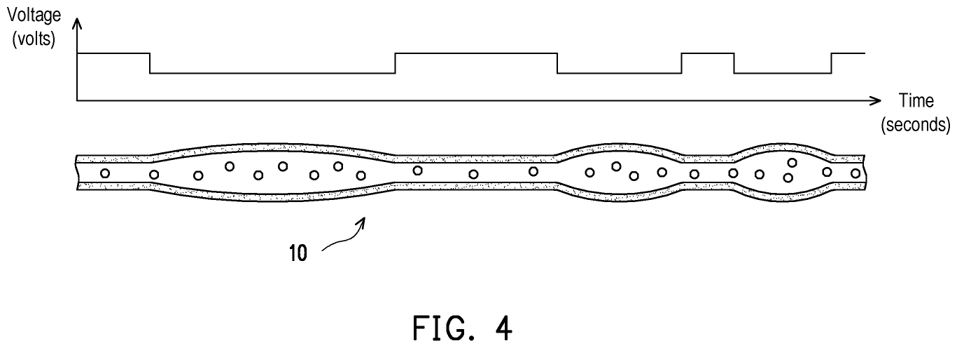

FIG. 4 is a comparison schematic view of the voltage change of the high voltage power supply and the cross-sectional change of the micron fiber in FIG. 1. With reference to FIGS. 1, 2, and 4, the strength of the electric field formed between the nozzle 130 and the printing platform 110 is changed based on the control of the level of the output voltage of the high voltage power supply 140, so as to instantly control the size of the diameter of the extruded filament of the printing material accordingly. Since the distance D between the nozzle 130 and the printing platform 110 is less than or equal to 1 cm, during the process of varying the level of the output voltage, the high voltage electric field between the nozzle 130 and the printing platform 110 still has enough strength to accurately deposition model the micron fiber on the printing platform 110 according to a printing pattern or a printing path.

When the output voltage is increased, the strength of the electric field formed between the nozzle 130 and the printing platform 110 is strengthened, so that the printing material extruded from the nozzle 130 is pulled by the high voltage electric field to form a thinner micron fiber 10, which is deposition modelled on the printing platform 110. In other words, as shown in FIG. 4, the cross-section or the diameter of the filament of the micron fiber 10 decreases as the output voltage increases. When the output voltage is decreased, the strength of the electric field formed between the nozzle 130 and the printing platform 110 is weakened, so that the printing material extruded from the nozzle 130 is pulled by the high voltage electric field to form a thicker micron fiber 10, which is deposition modelled on the printing platform 110. In other words, as shown in FIG. 4, the cross-section or the diameter of the filament of the micron fiber 10 increases as the output voltage decreases.

In summary, by forming the high voltage electric field between the nozzle and the printing platform, the three-dimensional printing apparatus having electrostatic auxiliary of the disclosure allows the printing material extruded from the nozzle to be pulled by the high voltage electric field to form the micron fiber, which is deposition modelled on the printing platform. In other words, the three-dimensional printing apparatus having electrostatic auxiliary can reduce the diameter of the extruded filament of the printing material. For example, the diameter of the extruded filament of the printing material is controlled to be between 80 microns and 450 microns. In addition, the strength of the electric field formed between the nozzle and the printing platform is changeable based on the control of the level of the voltage, so as to instantly control the size of the diameter of the extruded filament of the printing material accordingly. On the other hand, since the distance between the nozzle and the printing platform is less than or equal to 1 cm, during the process of varying the voltage, the high voltage electric field between the nozzle and the printing platform still have enough strength to accurately deposition model the micron fiber on the printing platform according to a printing pattern or a printing path.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A three-dimensional printing apparatus having electrostatic auxiliary, comprising:
a printing platform;
a feeding device, disposed above the printing platform;
a nozzle, disposed above the printing platform and connected to the feeding device, wherein the nozzle is located between the feeding device and the printing platform, and a distance between the nozzle and the printing platform is less than or equal to 1 cm; and
a high voltage power supply, having an output end and a ground end, wherein the output end is electrically connected to the nozzle, and the ground end is electrically connected to the printing platform.

2. The three-dimensional printing apparatus having electrostatic auxiliary according to claim 1, wherein the nozzle comprises a first discharge tube and a second discharge tube surrounding the first discharge tube, the feeding device comprises a first feeding device and a second feeding device juxtaposed with the first feeding device, the first feeding device is connected to the first discharge tube, and the second feeding device is connected to the second discharge tube.

3. The three-dimensional printing apparatus having electrostatic auxiliary according to claim 2, wherein the nozzle further comprises a first connecting tube and a second connecting tube, the first feeding device is connected to the first discharge tube through the first connecting tube, and the second feeding device is connected to the second discharge tube through the second connecting tube.

4. The three-dimensional printing apparatus having electrostatic auxiliary according to claim 2, wherein the first discharge tube and the second discharge tube are in a coaxial configuration.

5. The three-dimensional printing apparatus having electrostatic auxiliary according to claim 1, wherein the feeding device comprises a syringe, a plunger, and a pushing mechanism, the plunger is inserted into the syringe, and the pushing mechanism abuts the plunger.

6. The three-dimensional printing apparatus having electrostatic auxiliary according to claim 5, wherein the feeding device comprises a temperature control unit, and the syringe penetrates the temperature control unit.

7. The three-dimensional printing apparatus having electrostatic auxiliary according to claim 1, wherein the feeding device is maintained at a first temperature, the printing platform is maintained at a second temperature, and the first temperature is lower than the second temperature.

8. The three-dimensional printing apparatus having electrostatic auxiliary according to claim 1, further comprising a three-dimensional movement mechanism, wherein the printing platform is connected to the three-dimensional movement mechanism, and the printing platform is located between the nozzle and the three-dimensional movement mechanism.

9. The three-dimensional printing apparatus having electrostatic auxiliary according to claim 1, further comprising a controller, wherein the controller is electrically connected to the high voltage power supply.

10. The three-dimensional printing apparatus having electrostatic auxiliary according to claim 1, further comprising a temperature control device, connected to the printing platform.
